(19) United States
(12) Patent Application Publication
(10) Pub. No.: US 2011/0189623 A1
(43) Pub. Date: Aug. 4, 2011

(54) Orthodontic Bracket

(76) Inventors: Seung Soo MOON, Seoul (KR); Sung Hye MOON, Seoul (KR)

(21) Appl. No.: 13/019,559

(22) Filed: Feb. 2, 2011

(30) Foreign Application Priority Data
Feb. 4, 2010 (KR) 10-2010-0010440

(51) Int. Cl. A61C 7/16

(52) U.S. Cl. 433/9

(57) ABSTRACT

Disclosed herein is an orthodontic bracket which can be firmly attached to a tooth surface and can also be easily detached from the tooth surface after having been used. The orthodontic bracket includes a plurality of channels formed in a bonding surface of a base. Each of the channels is formed such that it is long in a direction perpendicular to the slot, and is open at a first side surface thereof located at a side surface of the base. Long and short side surfaces of the channels are inclined to serve as a locking step when the orthodontic bracket is attached to the surface of the tooth.

### BACKGROUND OF THE INVENTION

1. Field of the Invention

The present invention relates generally to orthodontic brackets and, more particularly, to an orthodontic bracket which can be firmly attached to a tooth surface and can also be easily detached from the tooth surface after having been used.

2. Description of the Related Art

Generally, a method of using orthodontic brackets to correct irregularities of the teeth is widely known to people. According to this method, after orthodontic brackets are secured to the surfaces of the teeth, the orthodontic brackets are connected by an archwire, so that the irregularities of the teeth are corrected by the force of the archwire.

A conventional orthodontic bracket includes a base and a bracket body. The base includes a bonding surface which is secured to a surface of the tooth via an adhesive. The bracket body is provided on a side opposite to the bonding surface of the base, and includes a slot which receives the archwire, and a wing to which a fastening member, such as an elastic O-ring or a bolt, is mounted to fasten the archwire. The orthodontic bracket must be firmly bonded to the tooth surface while the irregularities of the teeth are being corrected, and must be easy to detach from the tooth surface after having been used.

Therefore, in order to fulfill these requirements, a plurality of channels having undercuts is formed in the bonding surface of the base to improve bonding strength at the bonding surface.

Here, the undercut denotes an uneven or concave part of a product which prevents a mold from being removed from the product when the mold is operated in an opening direction after the product has been formed.

An undercut is formed in the orthodontic bracket to serve as a locking step for the adhesive, thus preventing the orthodontic bracket from unexpectedly becoming detached from the tooth surface.

However, since the conventional undercut of the channel formed in the bonding surface runs parallel in only one direction, bonding strength may be reduced when the force of the archwire acts on the orthodontic bracket in various directions.

Further, the conventional orthodontic bracket is problematic in that only bonding strength at the bonding surface is emphasized, so that the orthodontic bracket is not easy to detach from the tooth surface after the irregularities of the teeth have been corrected, and a lot of residual materials may remain behind on the tooth surface even after the orthodontic bracket has been detached from the tooth surface, so that it is not clean.

### SUMMARY OF THE INVENTION

Accordingly, the present invention has been made keeping in mind the above problems occurring in the prior art, and an object of the present invention is to provide an orthodontic bracket, which can be firmly attached to a tooth surface, can be easily detached from the tooth surface after having been used, and can minimize a residual material remaining behind on the tooth surface after being detached.

In order to accomplish the above object, the present invention provides an orthodontic bracket including a base which is provided on a first side of the bracket and has a bonding surface, and a bracket body which is provided on a second side opposite to the first side and has an archwire inserting slot formed along a central axis of the bracket body, the orthodontic bracket being attached to a surface of a tooth by an adhesive. Here, the bonding surface of the base includes a plurality of channels. Each of the channels is formed such that it is long in a direction perpendicular to the slot and is open at a first side surface thereof located at a side surface of the base. Long and short side surfaces of the channels are inclined to serve as a locking step when the orthodontic bracket is attached to the surface of the tooth.

The base may include a rupture guide groove which runs along a central axis of the base to be parallel to the slot.

A width of each of the channels may be gradually reduced in a direction from the side surface to a center of the base.

A wing may be provided on each of opposite sides of the slot to fasten the archwire to a predetermined position.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view showing an orthodontic bracket according to an embodiment of the present invention;

FIG. 2 is a plan view showing the orthodontic bracket according to the embodiment of the present invention; and

FIG. 3 is a view showing the orthodontic bracket according to the embodiment of the present invention, which is attached to a tooth surface.

### DESCRIPTION OF THE PREFERRED EMBODIMENTS

Hereinafter, an orthodontic bracket according to an embodiment of the present invention will be described in detail with reference to the accompanying drawings.

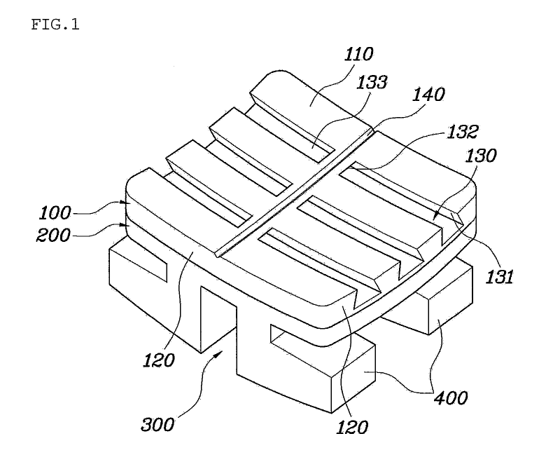

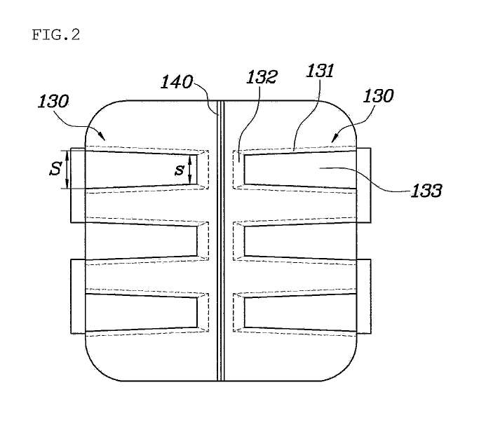

Referring to FIGS. 1 and 2, the orthodontic bracket according to the embodiment of the present invention includes a base 100 and a bracket body 200. A slot 300 is formed along the central axis of the bracket body 200.

The base 100 has the shape of a tetragon. In detail, the base 100 may have the shape of a square, rectangle or parallelogram.

The base 100 is provided with a bonding surface 110 which is attached to a tooth surface using an adhesive. The bonding surface 110 of the base 100 has the shape of a curved surface which is similar to that of the tooth, and may have a curved surface of a different shape depending on the tooth to which it is applied.

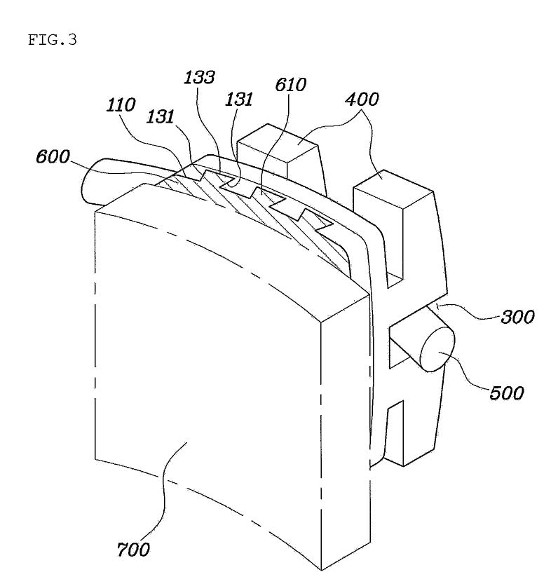

A plurality of channels 130 is provided in the bonding surface 110. Each channel 130 is open at one side surface thereof located at a side surface 120 of the base 100. The channel 130 is formed such that it is long in a direction perpendicular to the slot 300 which is formed along the central axis of the bracket body 200. The channel 130 includes a long side surface 131 which is formed in the length direction, a short side surface 132 which is formed along a side that is short in length, and a bottom surface 133. Here, it is preferable that the long and short side surfaces 131 and 132 be inclined. That is, when an adhesive 600 is applied to the bonding surface 110 of the base 100 to attach the orthodontic bracket to the tooth 700 as shown in FIG. 3, the inclined long and short side surfaces 131 and 132 serve as a locking step for the adhesive 600 which fills the channels 130 and solidifies in the channels 130. The locking step prevents the orthodontic bracket attached to the tooth 700 by the adhesive 600 from easily separating from the tooth 700, and allows the orthodontic bracket to be firmly retained on the tooth 700.

Meanwhile, the base 100 may further include a rupture guide groove 140 which runs along the central axis of the base 100 in such a way as to be parallel to the slot 300. The rupture guide groove 140 is formed by being cut in a V shape at a predetermined angle. The length of the rupture guide groove 140 is set such that facing side surfaces 120 of the base 100 are open.

Preferably, each channel 130 is formed such that a width S is gradually reduced in a direction from the side surface to the center of the base 100. Such a configuration prevents stress from concentrating on the rupture guide groove 140 when force is exerted on the orthodontic bracket using a detaching tool (not shown) or the like so as to detach the orthodontic bracket from the tooth surface, thus allowing the orthodontic bracket to be smoothly ruptured along the rupture guide groove 140.

The bracket body 200 is continuously formed to be opposite to the bonding surface 110 of the base 100, and the slot 300 is formed in the bracket body 200. Wings 400 may be provided on the left and right sides of the slot 300.

The width and depth of the slot 300 are set to receive an archwire 500 (see FIG. 3) therein. One or two wings 400 may be provided on the left and right sides of the slot 300 so that a fastening member (not shown) such as an O-ring or a bolt for fastening the archwire 500 to the slot 300 can be mounted to the wings. As necessary, no wing may be formed on the left and right sides of the slot 300.

Further, a concave dimple part (not shown) indicating a using position may be formed on a surface of the wing 400 so that an operator can visualize the tooth for which the orthodontic bracket is used.

Hereinafter, the operation of the orthodontic bracket according to the embodiment of the present invention, constructed as described above, will be described in detail.

Referring to FIGS. 1, 2, and 3, the orthodontic bracket is bonded to the surface of the tooth 700 via the adhesive 600 which is selected by an operator or a bracket manufacturer.

In the case of applying the adhesive 600 to the central portion of the base 100, the adhesive 600 fills the channels 130 which are formed in the bonding surface 110 of the base 100, and is applied to the bonding surface 110 up to a predetermined height. Here, a surface of the adhesive 600 applied to the bonding surface 110 is level with a surface of the adhesive 600 filling up the channels 130. After the adhesive 600 has been applied to the base 100 in this way, the orthodontic bracket is bonded to the surface of the tooth 700. Subsequently, orthodontic treatment is carried out by a general method.

If the orthodontic bracket is bonded to the surface of the tooth as such, the adhesive 600 filling the channels 130 and the adhesive 600 applied to the bonding surface 110 are integrated with each other and then are adhered to and solidified on the surface of the tooth 700.

In this case, the area of the bonding surface 110 of the base 100 to which adhesive is applied can be considerably increased in comparison with the adhesive applying area when no channel is formed in the bonding surface 110, so that the orthodontic bracket can be firmly bonded to the surface of the tooth 700. The long and short side surfaces 131 and 132 of the channels 130, which are formed in the bonding surface 110 of the base 100 in such a way as to be inclined, serve as the locking step for the adhesive 610 applied from the bonding surface 110 to the bottom surface 133 of each channel 130 among the adhesive 600 applied to the base 100, thus enabling the orthodontic bracket to be firmly bonded to the surface of the tooth.

Meanwhile, in the case of correcting irregularities of the teeth by bonding the orthodontic bracket to the surface of the tooth and then connecting the orthodontic bracket to other orthodontic brackets using the archwire 500, even if the force of the archwire 500 acts on the orthodontic bracket in various directions, support force of the long side surfaces 131 running parallel in only one direction is compensated for by the short side surfaces 132, thus solving the problem of the bonding strength being reduced.

If force is exerted on the orthodontic bracket using the detaching tool (not shown) or the like so as to detach the orthodontic bracket from the surface of the tooth when orthodontic treatment has been completed after several months or years have been passed or when necessary, stress concentrates on the rupture guide groove 140 which is formed in the bonding surface 110 of the base 100 in a direction parallel to the slot 300 of the orthodontic bracket. Consequently, the orthodontic bracket is ruptured along the rupture guide groove 140 and detached from the tooth 700, so that the orthodontic bracket can be smoothly separated from the surface of the tooth 700, and a residual material remaining behind on the surface of the tooth 700 after being detached can be minimized.

As described above, the orthodontic bracket of the present invention accomplishes the following effects.

A plurality of channels is formed in a bonding surface of a base, so that, when the orthodontic bracket is attached to the surface of a tooth using an adhesive, the area of the base to which the adhesive is attached is increased, and thus the orthodontic bracket can be firmly bonded to the tooth surface.

Long and short side surfaces of a channel formed in the bonding surface of the base serve as a locking step for the adhesive applied from the bonding surface to a bottom surface of the channel, among the adhesive applied to the base, thus allowing the orthodontic bracket to be firmly bonded to the tooth surface.

A rupture guide groove is provided in the bonding surface of the base in such a way as to run along the central axis of the base and be parallel to the slot, so that the orthodontic bracket is ruptured along the rupture guide groove when the orthodontic bracket is detached from the tooth surface, thus allowing the orthodontic bracket to be easily detached from the tooth surface, and minimizing a residual material remaining behind on the tooth surface.

A width of the channel formed in the bonding surface of the base is gradually reduced in a direction from a side surface to a center of the base, so that stress concentrates on the rupture guide groove when the orthodontic bracket is detached from the tooth surface, thus realizing smooth rupturing at the rupture guide groove.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An orthodontic bracket comprising:
a base which is provided on a first side of the bracket and has a bonding surface, and a bracket body which is provided on a second side opposite to the first side and has an archwire inserting slot formed along a central axis of the bracket body, the orthodontic bracket configured to be attached to a surface of a tooth by an adhesive,
wherein the bonding surface of the base comprises a plurality of channels, each of the channels being formed such that it is long in a direction perpendicular to the slot and being open at a first side surface thereof located at a side surface of the base, long and short side surfaces of the channels being inclined to serve as a locking step when the orthodontic bracket is attached to the surface of the tooth.

2. The orthodontic bracket as set forth in claim 1, wherein the base comprises a rupture guide groove which runs along a central axis of the base to be parallel to the slot.

3. The orthodontic bracket as set forth in claim 2, wherein a width of each of the channels is gradually reduced in a direction from the side surface to a center of the base.

4. The orthodontic bracket as set forth in claim 3, wherein a wing is provided on each of opposite sides of the slot to fasten the archwire to a predetermined position.
